(19) United States
(12) Patent Application Publication
(10) Pub. No.: US 2026/0118613 A1
(43) Pub. Date: Apr. 30, 2026

(54) Optical and Electrical Composite Cable for Simultaneous Installation within Pipelines and Processing and Construction Methods Thereof

(71) Applicant: SUMEC MACHINERY AND ELECTRIC CO., LTD., Nanjing (CN)

(72) Inventors: Xubo Ye, Nanjing (CN); Chao Chen, Nanjing (CN)

(21) Appl. No.: 18/957,682

(22) Filed: Nov. 23, 2024

(30) Foreign Application Priority Data
Oct. 25, 2024 (CN) 202411502456.8

(51) Int. Cl. G02B 6/44; G02B 6/50; H01B 9/00; H01B 13/24

(52) U.S. Cl. CPC G02B 6/4416; G02B 6/4479; G02B 6/502; H01B 9/005; H01B 13/24

(57) ABSTRACT

This application discloses an optical and electrical composite cable designed for simultaneous installation within pipelines, along with its processing and installation methods. By providing a composite cable with a thin wall and compact overall size, it allows the commercially available thin pipelines ranging from 6 mm to 13 mm in diameter to accommodate both optical and electrical cables in a single pass. This design reduces the amount of pipeline material needed and shortens installation time, while broadening the potential applications for these types of pipelines and improving their utilization. Since the optical and electrical composite cable is installed within a pipeline, it does not require self-supporting overhead structure, which simplifies its design. The thinner optical cable is connected to the thicker electrical cable, allowing the electrical cable to provide necessary tensile strength to the optical cable. This simplified approach to tensile strength ensures that the composite cable meets required strength standards despite its smaller size.

### TECHNICAL FIELD

This application is related to the field of optical and electrical composite cables, specifically, an optical and electrical composite cable along with its processing and construction methods.

### BACKGROUND ART

In building construction, pipelines are often pre-installed to facilitate future wiring, with thin pipelines ranging from 6 mm to 13 mm in diameter made up the largest share in the current market. When wiring installation is eventually needed, cables or optical fibers are usually separately routed through the pipelines as required.

In existing technology, due to the small size of these pipelines and the relatively large size of commercially available optical and electrical composite cables that meet performance standards, the common practice is to run a single electrical cable or optical fiber through each pipeline independently. To complete the wiring within a building, this setup requires dedicating a separate pipeline for each electrical cable or optical fiber, which results in low pipeline utilization, redundant installations, and wasted labor and resources.

### SUMMARY OF THE INVENTION

This application provides an optical and electrical composite cable for simultaneous installation within pipelines, along with processing and construction methods to address the technical challenges of the existing composite cables being incompatible with thin pipelines of 6 mm to 13 mm in diameter for simultaneous installation.

In a first aspect, this application provides an optical and electrical composite cable for simultaneous installation within pipelines. The cable includes a first outer sheath and a second outer sheath, which are adjacent to each other and fixed together; the first outer sheath encloses a number of optical fibers, and the second outer sheath encloses an electrical conductor. The connection between the first and second outer sheaths can be separated by tearing.

The wall thickness of both the first and second outer sheaths is between 0.1 mm and 1.5 mm.

The outer diameter of the first outer sheath is smaller than that of the second outer sheath, and the maximum outer diameter of the composite cable is between 4.0 mm and 12 mm.

Further, the number of the optical fibers are either tightly-buffered or semi-tightly-buffered, with a tensile elongation of the buffering material of at least 100%.

Additionally, the thickness of the connection between the first and second outer sheaths is less than the smaller wall thickness of either sheath by 0.1 mm to 1.45 mm.

Moreover, the number of optical fibers ranges from 1 to 4 cores.

The electrical conductor is either a solid copper wire or multi-strand twisted copper wire, with an internal stress less than or equal to a first preset value.

In a second aspect, this application provides a processing method for the optical and electrical composite cable. The method comprises the following steps.

Using extrusion equipment, the first and second outer sheaths are separately wrapped around the outermost surface of the number of optical fibers and the electrical conductor, fixing them adjacent to each other to obtain a primary optical and electrical composite cable.

The primary optical and electrical composite cable is then sequentially subjected to at least a first and a second vacuum cooling and forming process. The temperature of the first vacuum cooling is T1, and the temperature of the second vacuum cooling is T2, where T1 is greater than T2.

Furthermore, T1 is between 75° C. and 55° C., T2 is between 50° C. and 30° C., and the temperature difference between T1 and T2 is between 15° C. and 30° C.

Before the extrusion equipment wraps the first and second outer sheaths around the number of the optical fibers and electrical conductor, reducing the internal stress of the electrical conductor through a relaxation process by applying a first counter-twist parameter.

Additionally, after the primary optical and electrical composite cable undergoes the first and second vacuum cooling and forming processes, the cable is straightened and sequentially passed through marking equipment to apply a series of first markings on its surface.

If changes in the relative position of these first markings along the length of the optical and electrical composite cable, relative to the first and second outer sheaths, exceed a second preset value, the first counter-twist parameter is adjusted to a second counter-twist parameter until the relative position changes are below the second preset value.

Further, after the primary optical and electrical composite cable undergoes the first and second vacuum cooling and forming processes, the primary optical and electrical composite cable is straightened to obtain the center positions A1 and B1 of the first and second outer sheaths at a first cross-sectional location and the center positions A2 and B2 of the first and second outer sheaths at a second cross-sectional location.

The centerline A1B1 is established between A1 and B1, and the centerline A2B2 between A2 and B2.

The angle θ between centerlines A1B1 and A2B2 is calculated. If the rate of change of angle θ along the length of the composite cable exceeds a third preset value, the first counter-twist parameter is adjusted to a second counter-twist parameter until the rate of change is below the third preset value.

In a third aspect, this application provides a construction method for using the optical and electrical composite cable obtained according to the first or second aspects by inserting and threading it through pipelines with an inner diameter of 6 mm to 13 mm.

Further, this method includes the following steps.

Selecting a maximum outer diameter D2 of the optical and electrical composite cable to meet the requirement that D2+0.1≤D1, where D1 is an inner diameter of the pipeline.

Inserting and threading the composite cable into the pipeline such that the second outer sheath is in contact with the inner wall of the pipeline, while the first outer sheath is positioned away from the inner wall.

Moreover, when threading the composite cable through the pipeline, the second outer sheath is positioned close to the inner wall of the pipeline, near the area where the centerline connecting the first and second sheaths intersects the cross-section of the pipeline on the side of the second sheath.

Additionally, the method of threading the composite cable into the pipeline with the second outer sheath in contact with the inner wall and the first outer sheath positioned away from it comprises. Using a flexible, elongated cord as a guide element, with a length beyond the free end of the composite cable that is longer than the length of the pipeline; securing one end of the guide element to the free end of the composite cable.

Inserting the free end of the guide element into the first end of the pipeline and threading it out of the second end.

Identifying a first region on the pipeline where the composite cable will be in close contact with the pipeline during threading.

Determining a force application direction for the guide based on the position of this first region at the second end of the pipeline, in between this position and the exit direction of the second end.

Pulling the guide element in the determined direction until the composite cable is threaded from the first end to the second end of the pipeline.

Moreover, determining the first position of the pipeline based on the relative position between the first region and an external marking on the pipeline, then aligning this relative position at the second end of the pipeline to determine the first position.

Additionally, the angle between the force application direction and the exit direction of the second end of the pipeline is between 10° and 60°.

### Beneficial Effects

The optical and electrical composite cable, along with its processing and construction methods for simultaneous installation within pipelines, provides a thin-walled, compact composite cable that allows commercially available thin pipelines ranging from 6 mm to 13 mm to accommodate both optical and electrical cables in a single pass. This reduces the amount of pipeline material and installation time, expands the application scenarios of such pipelines, and improves pipeline utilization.

Since the optical and electrical composite cable is installed within a pipeline, it does not require a self-supporting overhead structure, simplifying its design. Additionally, the thinner optical cable portion is connected to the thicker electrical cable section, which provides necessary tensile strength to the optical cable. This simplifies the tensile strength requirements of the optical cable, ensuring that the composite cable meets performance standards even with its smaller size.

### DESCRIPTION OF THE DRAWINGS

The drawings, which form part of this application, provide a further understanding of this application. The exemplary embodiments and descriptions are used to explain this application but do not constitute undue limitations on it. In the drawings:

FIG. 1 is a cross-sectional schematic illustration of one embodiment of an optical and electrical composite cable.

FIG. 2 is a cross-sectional schematic illustration of a second embodiment of an optical and electrical composite cable.

FIG. 3 is a cross-sectional schematic illustration of a third embodiment of an optical and electrical composite cable.

FIG. 4 is a cross-sectional schematic illustration of a fourth embodiment of an optical and electrical composite cable.

FIG. 5 is a cross-sectional schematic illustration of an optical and electrical composite cable under torsion.

FIG. 6 is a longitudinal sectional schematic illustration showing an optical and electrical composite cable inside a pipeline.

FIG. 7 is a cross-sectional schematic illustration of an optical and electrical composite cable inside a pipeline.

FIG. 8 is a side view of a schematic illustration of the optical and electrical composite cable inside the pipeline.

FIG. 9 is a side view of another schematic illustration of the optical and electrical composite cable inside the pipeline.

The elements of reference numerals in the figures are as follows:
1—First outer sheath; 2—Reinforcing yarn; 3—Connection point or connection; 4—Optical fiber; 5—Electrical conductor; 6—Insulation layer; 7—Second outer sheath; 8—Isolation framework; 9—Pipeline.

### DETAILED DESCRIPTION

It should be noted that, where there is no conflict, the embodiments and features of this application can be combined. The following description references the drawings and details various embodiments of this application.

In the descriptions in this application, terms like “center,” “longitudinal,” “transverse,” “length,” “width,” “thickness,” “upper,” “lower,” “front,” “back,” “left,” “right,” “vertical,” “horizontal,” “top,” “bottom,” “inner,” “outer,” “clockwise,” and “counterclockwise” indicate orientation or positional relationships based on the drawings. These terms are only used to facilitate explanation and should not imply any specific construction or orientation constraints on the components or elements, nor should they limit this application.

Also, the terms “first” and “second” are used solely for descriptive purposes and do not indicate importance or imply specific quantities of the features. Thus, features designated as “first” or “second” may include one or more instances of those features, either expressly or implicitly. In this application, “multiple” means two or more, unless explicitly specified otherwise.

Terms like “installation,” “connected,” and “linked” should be understood broadly, covering fixed and detachable connections, integral connections, mechanical or electrical connections, direct or indirect connections, and connections that allow communication or interaction. These terms should be interpreted based on context by those skilled in the art.

This embodiment provides an optical and electrical composite cable designed to be threaded through small-diameter pipelines, specifically pipelines with an inner diameter of 6 mm to 13 mm, commonly used in construction. During installation, such pre-embedded pipelines in the building are used to install cables, typically with each pipeline containing a single cable, such as a power cable, data cable, or optical fiber.

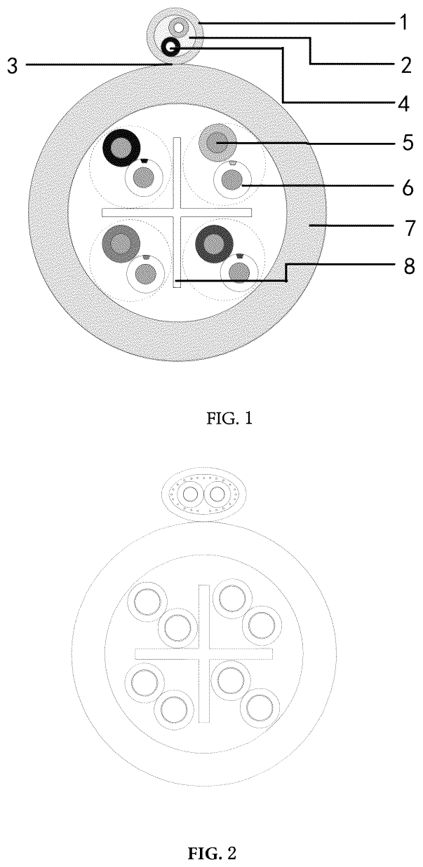

As shown in FIG. 1, the optical and electrical composite cable in this embodiment has a cross-sectional diameter smaller than the inner diameter of the pipeline, allowing it to be laid within the pipeline in a single pass. This composite cable comprises a fiber-optic cable portion and an electrical cable section, with a first outer sheath 1 and a second outer sheath 7 that are adjacent and fixed together. The first outer sheath 1 houses an optical fiber 4, forming the optical cable section, while the second outer sheath 7 houses an electrical conductor 5, forming the electrical cable section. The first outer sheath 1 protects the optical fiber 4, and the second outer sheath 7 protects the electrical conductor 5.

Since the optical fiber 4 is thin and the electrical conductor 5, typically a copper wire, is thicker, the outer diameter of the first outer sheath 1 is smaller than that of the second outer sheath 7, with the maximum outer diameter of the composite cable being between 4.0 mm and 12 mm, making it compatible with current commercially available pipeline resources. In certain embodiments, the outer diameter of the first outer sheath 1 ranges from 1 mm to 4 mm, and that of the second outer sheath 7 ranges from 5 mm to 10 mm, adjustable according to the required specifications.

To ensure that the first and second outer sheaths provide adequate protection, their thicknesses are designed with sufficient thickness. However, since the composite cable is placed within a pipeline that provides additional support and protection, the tensile strength requirements-particularly for the optical fiber section-are relatively low. Consequently, the thicknesses of the first and second outer sheaths need not be excessively large, and there is no need for additional reinforcing structures like tensile rods. In this embodiment, the wall thickness of the first and second outer sheaths is between 0.1 mm and 1.5 mm, with the first outer sheath generally thinner than the second. For instance, the first outer sheath 1 has a wall thickness of 0.3 mm to 0.5 mm, and the second outer sheath 7 has a thickness of 0.5 mm to 1 mm, selected based on strength requirements and pipeline diameter to balance protection, tensile strength, and overall size control.

The cross-sectional profile of the composite cable is defined by the shape, number, and connection of the first and second outer sheaths. Common profiles include variations among both sheaths being circular, one circular and the other polygonal, or both polygonal. Polygonal means equal to or more than triangles.

In certain preferred embodiments, as shown in FIG. 1, both the first outer sheath 1 and the second outer sheath 7 have circular cross-sectional shapes, and there is one of each. The contact surface between the composite cable and the pipeline 9 during threading is therefore curved, which helps reduce friction and prevents stress concentration during installation. This design facilitates easier installation and reduces the risk of damage to the composite cable.

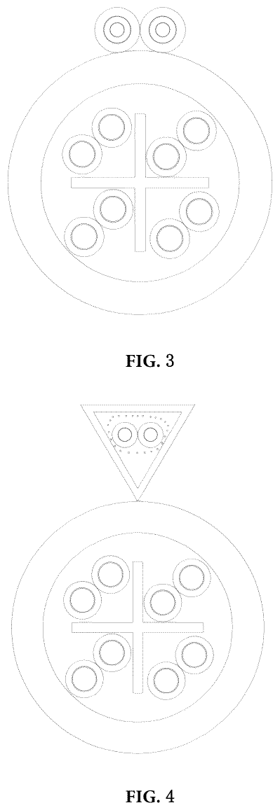

In addition to the cross section profile shown in FIG. 1, FIGS. 2 through 4 illustrate other typical cross-sectional profiles for the optical and electrical composite cable. FIG. 2 shows an optical and electrical composite cable with one first outer sheath 1 having an elliptical ring-shaped cross-section and one second outer sheath 7 with a circular ring-shaped cross-section. FIG. 3 shows a composite cable with two first outer sheaths 1 and one second outer sheath 7, where the two first outer sheaths 1 are arranged adjacent to each other on the exterior of the second outer sheath 7, and both the first and second outer sheaths have circular cross-sections. FIG. 4 shows a composite cable with one first outer sheath 1 having a triangular ring-shaped cross-section and one second outer sheath 7 with a circular ring-shaped cross-section.

It is worth noting that these different profiles are for illustrative purposes only and do not exhaustively represent all possible embodiments. For simplicity, the primary description will focus on the cross-sectional profile shown in FIG. 1, with other embodiments described in reference to it.

The connection between the first outer sheath 1 and the second outer sheath 7 are configured to meet the following requirements: when separation is not needed, the first and second outer sheaths should or remain connected; however, when separation is required, the first and second outer sheaths can be easily separated. Additionally, to keep the outer diameter of the composite cable as small as possible, the connection point 3 should be as short and thin as possible while still maintaining the connection between the first and second outer sheaths. Specifically, the connection 3 is designed to be short along the direction connecting the two sheaths and thin in the direction perpendicular to that. This structure, with a small thin wall between two thicker walls, allows easy separation when needed by applying force at the first and second outer sheaths along the extension direction of the thin wall. This configuration enables simple shearing along the extension of the thin wall to separate the first and second outer sheaths 1 and 7.

Therefore, in certain preferred embodiments, the thickness of the connection 3, in the direction perpendicular to the connection between the first outer sheath 1 and the second outer sheath 7, is set to be between 0.1 mm and 1.45 mm less than the wall thickness of the thinner of the two sheaths. The length of the connection point 3, along the direction connecting the first and second outer sheaths, is less than 0.1 mm. For example, if the first outer sheath 1 has a wall thickness of 0.3 mm and the second outer sheath 7 has a wall thickness of 0.6 mm, the thickness of the connection point 3 would be 0.1 mm, or 0.2 mm less than the wall thickness of the first outer sheath. The length of the connection point 3 would be 0.05 mm. As shown in FIG. 1, the connection point 3 is located between the first outer sheath 1 and the second outer sheath 7, and its size is extremely small, making it almost invisible in the figure. This design gives the composite cable a cross-section resembling an ‘8’ shape, with one end larger than the other.

In certain preferred embodiments, the materials of the first outer sheath 1, second outer sheath 7, and connection point 3 are flame-retardant, such as LSZH (low-smoke zero halogen) or PVC.

In certain preferred embodiments, the optical fiber 4 is a tightly-buffered or semi-tightly-buffered fiber, using a buffering material with a tensile elongation of at least 100%. This buffering keeps the optical cable portion as compact as possible. In specific embodiments, tightly-buffered optical fibers are used, with the outer diameter controlled between 0.4 mm and 0.9 mm, depending on the inner diameter of the pipeline 9. The material of the buffering layer surrounding the optical fiber 4 is preferably thermoplastic, such as LSZH, PVC, PA, TPU, or TPEE, and the buffering material can be stripped to a length of over 3 cm with fiber strippers without damaging the optical fiber.

In certain preferred embodiments, the number of optical fibers 4 is between 1 and 4 cores. The optical fibers 4 are preferably G657 fibers, which have excellent bending performance, making them suitable for small-radius bends commonly required in indoor installations.

In the embodiment shown in FIG. 1, a reinforcing yarn 2 is provided around the optical fiber 4 to enhance the tensile strength of the optical cable. The reinforcing yarn 2 may be made from aramid, fiberglass, polyester, or other tensile-strength yarn materials. In this embodiment, the strength of the optical cable is partially dependent on the reinforcing yarn 2 and partially on the electrical cable portion. Therefore, aside from the reinforcing yarn 2, there are no additional reinforcing elements inside or outside the first outer sheath 1.

In certain preferred embodiments, the electrical conductor 5 is either a solid copper wire or multi-strand twisted copper wire. To prevent significant positional shifts between the optical and electrical cable portions along the cable's length due to conductor twisting, the internal stress of the conductor 5 is limited to a first preset value. In the embodiment shown in FIG. 1, the conductor 5 consists of four pairs of twisted copper wires, each pair containing two copper wires and corresponding insulation layer 6, forming four conductors with diameters between 22 AWG and 26 AWG. In this embodiment, an isolation framework 8 is also included within the first outer sheath to separate the four twisted pairs, optimizing transmission performance. In some embodiments, if transmission performance meets requirements without the isolation framework 8, it may be removed to reduce the size of the conductor portion.

Embodiments of the present invention further provide a processing method for an optical and electrical composite cable, comprising the following steps.

Step S101: Using extrusion equipment, the first outer sheath 1 and the second outer sheath 7 are respectively wrapped around the outermost parts of the optical fiber 4 and the electrical conductor 5, ensuring that the first outer sheath 1 and the second outer sheath 7 are fixed together adjacently, thereby obtaining a primary optical and electrical composite cable.

Step S102: The primary optical and electrical composite cable undergoes at least a first vacuum cooling and forming process and a second vacuum cooling and forming process in sequence, where the temperature for the first vacuum cooling and forming process is T1, and the temperature for the second vacuum cooling and forming process is T2, with T1 being greater than T2.

In the above processing method, the components within the first outer sheath 1 and second outer sheath 7 are positioned as designed and passed through the extrusion equipment. The extrusion equipment heats the materials of the first and second outer sheaths to approximately 200° C., causing them to melt. Through a mold, the first and second outer sheaths are shaped to wrap around their respective components, connecting the first outer sheath 1 and the second outer sheath 7 adjacently on the outside. When applied to the optical and electrical composite cable shown in FIG. 1, this process allows the extrusion equipment to encapsulate the optical fiber 4 and reinforcing yarn 2 within the first outer sheath 1, and the copper wire, insulation layer 6, and isolation framework 8 within the second outer sheath 7, forming a connection between the two sheaths resembling the shape of an ‘8.’

After emerging from the extrusion equipment, the primary optical and electrical composite cable's first outer sheath 1 and second outer sheath 7 are still warm and relatively soft. At this point, the sheaths have not fully formed tightly around their internal components. By subjecting the primary composite cable to a two-stage vacuum cooling and forming process, where it is gradually cooled in vacuum forming equipment, the first and second outer sheaths shrink slowly and evenly. This ensures the composite cable maintains its roundness and that the inner and outer surfaces of the sheaths are smooth and even, resulting in a finished composite cable with uniform inner and outer diameters.

In certain preferred embodiments, T1 is set between 75° C. and 55° C., T2 is between 50° C. and 30° C., and the temperature difference between T1 and T2 is between 15° C. and 30° C.

Strict control of size and shape is crucial for this embodiment of the optical and electrical composite cable.

On one hand, for the interior of the composite cable, a uniform wrapping between the first outer sheath 1 and the optical fiber 4 ensures an even, smooth surface, which prevents localized excessive pressure on the optical fiber 4 that could otherwise cause damage and increased signal attenuation. A uniform wrapping between the second outer sheath 7 and the conductor 5 helps reduce stress on the conductor 5, ensuring stable transmission performance and maintaining a consistent pitch in the conductor cable section. In the embodiment shown in FIG. 1, the stress on the conductor 5 primarily comes from the multi-strand twisted copper wires. If this stress is not relieved, it may cause a positional shift along the length of the composite cable during extrusion, resulting in twisting. Since the composite cable is eventually installed within pipeline 9, significant twisting could lead to changes in the relative position between the cable and the pipeline at different cross-sectional points. This would hinder the threading process and could cause wear on the optical cable where it makes close contact with the pipeline 9.

On the other hand, because the composite cable is installed within pipeline 9, and both the pipeline's inner diameter and the cable's outer diameter are relatively small, the clearance between them is minimal. For example, in a pipeline 9 with an inner diameter of 13 mm, the maximum outer diameter of a composite cable that can be threaded through is 12 mm, leaving only a 1 mm gap. Poor control of the composite cable's outer diameter, especially if the diameter is too large, would increase friction during installation or could even prevent threading altogether. Additionally, a poorly controlled outer diameter or noticeable twisting could lead to severe compression between the optical cable section and the inner wall of pipeline 9, resulting in potential damage to the optical cable.

Therefore, for the reasons mentioned above, in certain preferred embodiments, before using the extrusion equipment to wrap the first outer sheath 1 and second outer sheath 7 around the optical fiber 4 and electrical conductor 5, the method comprises the following steps.

Step S100: Applying a relaxation process using a counter-twist parameter to the electrical conductor 5 to reduce its internal stress. This counter-twist parameter is provided by a relaxation device, which applies the specified counter-twist parameter to the conductor 5 before it enters the extrusion equipment, thereby minimizing its internal stress as much as possible and reducing the likelihood of twisting in the formed composite cable.

After the composite cable is formed, it is necessary to assess whether the relaxation process on electrical conductor 5 has been sufficient. Based on the results, adjustments to the counter-twist parameter can be made as needed.

In certain preferred embodiments, after the primary optical and electrical composite cable has sequentially undergone at least a first and second vacuum cooling and forming process, the method comprises the following steps.

Step S103: Straightening the composite cable and passing it through marking equipment to apply a series of first markings on its surface.

Step S104: If the relative position of these first markings along the length of the composite cable, in relation to the first outer sheath 1 and second outer sheath 7, varies by more than a second preset value, the counter-twist parameter is adjusted from the first to a second counter-twist parameter until the variation is less than or equal to the second preset value.

In this method, since the marking equipment applies markings at fixed points, the markings should theoretically maintain a consistent relative position along the length of the composite cable. However, if the composite cable experiences twisting, the relative position of the optical cable portion and electrical conductor 5 will vary at different cross-sections along the length. For example, if the twist direction is clockwise or counterclockwise, the position of the optical cable relative to the electrical cable will gradually shift along the length of the cable, rotating around the conductor clockwise or counterclockwise. Generally, the greater the stress on the electrical conductor 5, the more pronounced the twisting, and the more evident the relative position shift between the optical and electrical portions. This embodiment uses the variation in position of the first markings relative to the first outer sheath 1 and second outer sheath 7 to detect and control this twisting. For example, if at one cross-section the first marking is on the second outer sheath 7, in a clockwise direction from the first outer sheath 1, and at another cross-section, it is on the first outer sheath 1, this indicates a noticeable shift in the first marking's position. Adjusting the counter-twist parameter until the markings consistently appear in stable, uniform positions on the composite cable can help control the twisting within a reasonable range.

To achieve the same objective, this invention also provides alternative embodiments for detecting and managing twisting in the composite cable. In these preferred embodiments, after the primary composite cable undergoes at least the first and second vacuum cooling and forming processes, the method comprises the following steps.

Step S105: Straightening the composite cable to determine the center position A1 of the first outer sheath 1 and center position B1 of the second outer sheath 7 at a first cross-sectional point, and the center position A2 of the first outer sheath 1 and center position B2 of the second outer sheath 7 at a second cross-sectional point.

Step S105: Determine the centerline A1B1 connecting the center position A1 of the first outer sheath 1 and the center position B1 of the second outer sheath 7, as well as the centerline A2B2 connecting the center position A2 of the first outer sheath 1 and the center position B2 of the second outer sheath 7.

Step S106: Calculate the angle θ between centerlines A1B1 and A2B2. If the rate of change in angle θ along the length of the composite cable exceeds a third preset value, adjust the counter-twist parameter from the first to the second counter-twist parameter until the rate of change in the relative position is less than or equal to the third preset value.

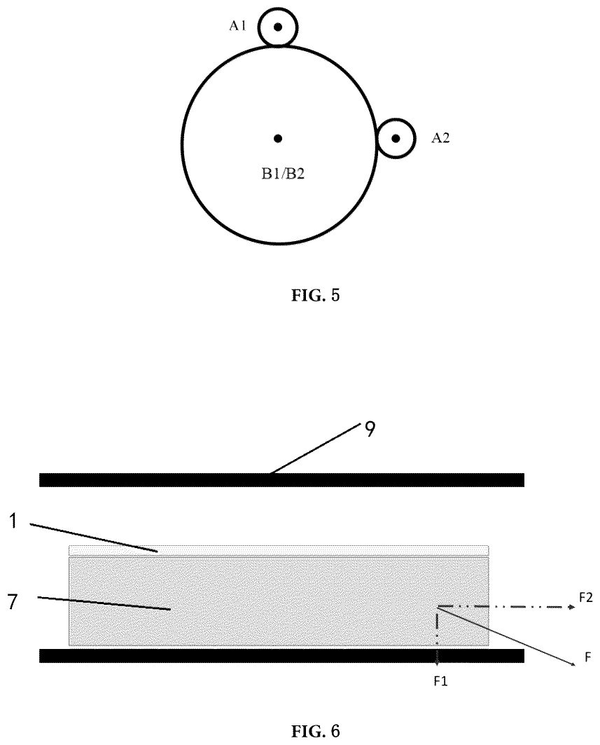

As shown in FIG. 5, in one embodiment, two cross-sections spaced 10 meters apart on the composite cable are superimposed, showing B1B2 aligned while A1 and A2 differ, with an angle θ of 90° between centerlines A1B1 and A2B2. In this embodiment, it is necessary to control θ to 0.2° or less between cross-sections spaced 10 meters apart, meaning that the third preset value requires that θ remain at or below 0.2° every 10 meters. Since the actual angle θ of 90° exceeds this value, the counter-twist parameter should be adjusted until the angle θ is re-measured and falls below the third preset value.

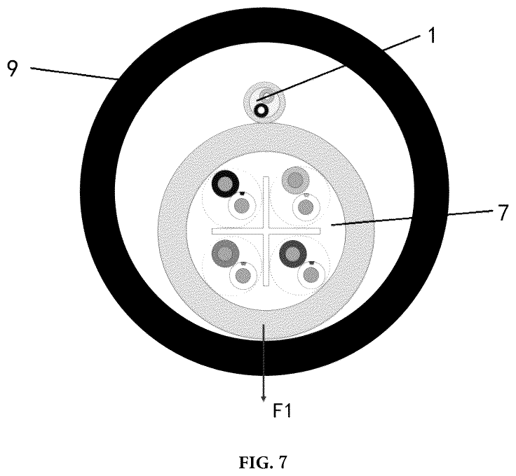

To facilitate smooth threading and protect the optical cable section, as shown in FIGS. 6 and 7, this application also provides a method for installing the composite cable, produced according to the embodiments described above or the processing methods disclosed in this application, by threading it through pipelines with an inner diameter of 6 mm to 13 mm.

Additionally, this method comprises the following steps.

Step S201: Select the maximum outer diameter D2 of the composite cable based on the inner diameter D1 of the pipeline to meet the requirement that D2+0.1≤D1.

Step S202: Thread the composite cable into pipeline 9 in such a way that the second outer sheath 7 is in close contact with the inner wall of the pipeline 9, while the first outer sheath 1 is positioned away from the inner wall of the pipeline 9.

In certain preferred embodiments, during threading, the second outer sheath 7 is positioned close to the inner wall of the pipeline 9, near the area where the centerline connecting the first outer sheath 1 and the second outer sheath 7 intersects the cross-section of pipeline 9 on the side of the second outer sheath 7.

As shown in FIG. 6, the outer wall of the second outer sheath 7 is in close contact with the inner wall of the pipeline 9, while the first outer sheath 1 is located on the opposite side of the contact point between the second outer sheath 7 and the pipeline 9. This setup keeps the more fragile optical cable section away from the pipeline, reducing its chances of contact and lowering the risk of damage during installation.

To achieve the installation method described in these embodiments, in certain preferred embodiments, the composite cable is threaded through pipeline 9 with the second outer sheath 7 in close contact with the inner wall of the pipeline 9 and the first outer sheath 1 positioned away from it, as follows.

Step S2021: Use a flexible, elongated cord as a guide element. The guide element's length, measured from the free end of the composite cable, must be longer than the length of pipeline 9. Attach one end of the guide element to the free end of the composite cable. The guide element provides pulling force from the outlet side of pipeline 9 during threading, allowing the composite cable to move from the inlet side to the outlet side under the applied traction.

Step S2022: Insert the free end of the guide element into the first end of pipeline 9 and pull it out from the second end. The first end serves as the inlet side of pipeline 9, while the second end serves as the outlet side. At this stage, without pulling the guide element, the composite cable remains outside pipeline 9.

Step S2023: Identify the first region of pipeline 9 where the composite cable will make close contact with the pipeline during threading. Before pulling the guide element, determine this first region at the inlet side of pipeline 9 to guide the pulling direction of the guide element.

Applying the correct force direction ensures that the composite cable is threaded through pipeline 9 as shown in FIGS. 6 and 7.

Step S2024: Based on the first region's corresponding position at the outlet side of pipeline 9, determine the guide element's pulling direction. This direction should lie between the corresponding position (first orientation) and the outlet direction of pipeline 9's second end.

Step S2025: Pull the guide element in the determined direction until the composite cable is threaded from the first end of pipeline 9 to the second end.

Given the length of pipeline 9, identify the corresponding position of the first region along the pipeline's cross-section at the outlet side based on its location at the inlet side. Use this corresponding position, relative to the center of pipeline 9, to define the first orientation. The pulling direction consists of traction force F2 along the length of pipeline 9 (from the first end to the second end) and pressure F1 along the first orientation. The resulting force F from these components ensures that the composite cable is threaded through pipeline 9 as shown in FIGS. 6 and 7.

In certain preferred embodiments, determining the first orientation based on the first region at the outlet side of pipeline 9 comprises the following steps.

Using external markings on pipeline 9 to establish the relative position between the first region and the marking. Based on this relative position, determine the first orientation at the outlet side of pipeline 9.

In certain preferred embodiments, the angle between the pulling direction and the outlet direction at the second end of pipeline 9 ranges from 10° to 60°.

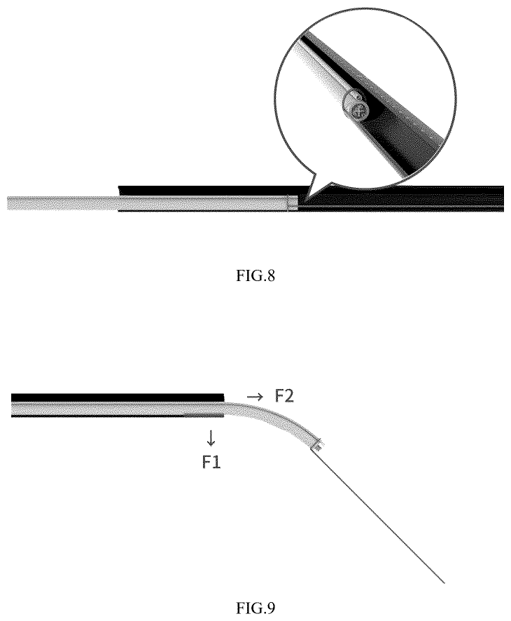

The red-line portion shown in the FIGS. 8 and 9, along with its extended line throughout the pipeline, defines the first region. If deformation of the composite cable under compression is not considered, this would be a single line; however, if compression deformation is considered, it should be a small arc surface. The markings are represented by the dots on the pipeline in FIGS. 8 and 9. How the first region at the outlet of the pipeline is determined used the aid of these dots. These dots, marked on the exterior of the pipeline, maintain a relatively fixed position along the length of the pipeline. Therefore, once the first region is determined at the pipeline inlet, the relative positional relationship between the first region and the dots is established. This relationship remains valid at the pipeline outlet. Consequently, the first region's position at the pipeline outlet can be determined based on its relative alignment with the dots, referred to as the first orientation. This orientation ensures that force can be appropriately applied.

The construction method provided in these embodiments ensures that the optical cable is protected from external pressure during installation, maintaining normal signal attenuation.

The above descriptions are merely examples of this application and are not intended to limit its scope. Those skilled in the art can make various modifications and changes within the spirit and principles of this application. Any modifications, equivalent substitutions, or improvements that fall within the spirit and principles of this application are included within its scope of claims.

1. An optical and electrical composite cable for simultaneous installation within pipelines, comprising
a first outer sheath and a second outer sheath, which are adjacent and fixed together;
the first outer sheath encloses a number of optical fibers, and
the second outer sheath encloses an electrical conductor;
a connection between the first and second outer sheaths can be separated by tearing;
wherein wall thickness of both the first and second outer sheaths is between 0.1 mm and
1.5 mm; outer diameter of the first outer sheath is smaller than that of the second outer sheath, with a maximum outer diameter of the optical and electrical composite cable being between 4.0 mm and 12 mm.

2. The optical and electrical composite cable according to claim 1, wherein
the optical fibers are either tightly-buffered or semi-tightly-buffered with a buffering material, with a tensile elongation of the buffering material of at least 100%.

3. The optical and electrical composite cable according to claim 1, wherein
a thickness of the connection between the first and second outer sheaths is less than a smaller wall thickness of either sheath by 0.1 mm to 1.45 mm.

4. The optical and electrical composite cable according to claim 1, wherein
the number of optical fibers is between 1 and 4 cores.

5. The optical and electrical composite cable according to claim 1, wherein
the electrical conductor is either a solid copper wire or multi-strand twisted copper wire, with an internal stress less than or equal to a first preset value.

6. A processing method for an optical and electrical composite cable as characterized by comprising the following steps:
using extrusion equipment, a first and second outer sheaths are used separately to wrap around outermost surface of the optical fiber and electrical conductor, fixing the first and second outer sheaths adjacent to each other to obtain a primary optical and electrical composite cable; said primary optical and electrical composite cable is then subjected to at least a first and a second vacuum cooling and forming process to obtain a final formed optical and electrical composite cable wherein a temperature of the first vacuum cooling is T1, and a temperature of the second vacuum cooling is T2, where T1 is greater than T2.

7. The method according to claim 6, wherein T1 is between 75° C. and 55° C., T2 is between 50° C. and 30° C., and a temperature difference between T1 and T2 is between 15° C. and 30° C.

8. The method according to claim 6, further comprising the step of
reducing the internal stress of the electrical conductor according to a first counter-twist parameter to the electrical conductor before wrapping the first and second outer sheaths around the optical fiber and electrical conductor using the extrusion equipment.

9. The method according to claim 8, further comprising the step, after the primary optical and electrical composite cable undergoes at least the first and second vacuum cooling and shaping, of:
straightening the optical and electrical composite cable and using marking equipment to apply a series of first markings on its surface;
when changes in a relative position of these first markings along a length of the primary optical and electrical composite cable, relative to the first and second outer sheaths, exceed a second preset value, adjusting the first counter-twist parameter to a second counter-twist parameter until the relative position changes are under the second preset value.

10. The method according to claim 8, further comprising the step, after the primary optical and electrical composite cable undergoes at least the first and second vacuum cooling and shaping, of:
straightening the optical and electrical composite cable and determining center positions A1 and B1 of the first and second outer sheaths at a first cross-sectional location and the center positions A2 and B2 of the first and second outer sheaths at a second cross-sectional location;
establishing a centerline A1B1 between A1 and B1, and a centerline A2B2 between A2 and B2;
calculating an angle θ between centerlines A1B1 and A2B2; when a rate of change of angle θ along the length of the optical and electrical composite cable exceeds a third preset value,
adjusting the first counter-twist parameter to the second counter-twist parameter until the rate of change is under the third preset value.

11. A construction method for an optical and electrical composite cable comprising
providing the optical and electrical composite cable of claim 1;
using the optical and electrical composite cable by threading it through a pipeline with an inner diameter of 6 mm to 13 mm.

12. The method according to claim 11, comprising the steps of:
selecting a maximum outer diameter D2 of the optical and electrical composite cable to meet the requirement that D2+0.1≤D1, where D1 is the inner diameter of the pipeline;
threading the optical and electrical composite cable into the pipeline such that the second outer sheath is in contact with the inner wall of the pipeline, while the first outer sheath is positioned away from the inner wall of the pipeline.

13. The method according to claim 12, wherein the second outer sheath is positioned to be in contact with the inner wall of the pipeline, at a location near where the centerline connecting the first and second outer sheaths intersects the pipeline cross-section on the side of the second outer sheath.

14. The method according to claim 12, wherein the step of threading the optical and electrical composite cable into the pipeline such that the second outer sheath is in contact with the inner wall of the pipeline, while the first outer sheath is positioned away from the inner wall of the pipeline, comprising:
using a flexible, elongated cord as a guide element, with a length beyond a free end of the optical and electrical composite cable that is longer than the length of the pipeline;
securing one end of the guide element to the free end of the optical and electrical composite cable;
inserting the free end of the guide element into the first end of the pipeline and threading out of the second end of the pipeline;
identifying a first region on the pipeline, where the optical and electrical composite cable will be in close contact with the pipeline during threading;
determining a force direction for the guide to be based on the position of this first region at the second end of the pipeline, determine the force direction for the guide to be between this position and the exit direction of the second end of the pipeline; and
pulling the guide element in the determined direction until the optical and electrical composite cable is threaded from the first end to the second end of the pipeline.

15. The method according to Claim 14, wherein the first position is determined based on the relative position between the first region and a marking on the exterior of the pipeline, aligning the relative position on the second end of the pipeline to determine the first position.

16. The method according to claim 14, wherein an angle between the force application direction and the exit direction of the second end of the pipeline is between 10° and 60°.
